(19) United States
(12) Patent Application Publication
(10) Pub. No.: US 2010/0274695 A1
(43) Pub. Date: Oct. 28, 2010

(54) UTILITY TARIFF ENGINE

(75) Inventors: Michael Thomas, Cambridge (CA); Calvin Irwin, Cambridge (CA); Christopher Powers, Cambridge (CA)

Correspondence Address: LifeCycle IP Management Inc., 24 Wellesley Street West, Suite 2110, Toronto, ON, M4Y 2X6, CA

(73) Assignee: MANAGING ENERGY INC., Cambridge (CA)

(21) Appl. No.: 12/765,654

(22) Filed: Apr. 22, 2010

Related U.S. Application Data
(60) Provisional application No. 61/172,401, filed on Apr. 24, 2009.

(51) Int. Cl. G06Q 50/00; G06Q 30/00; G06Q 10/00

(52) U.S. Cl. 705/34; 705/30; 705/412

(57) ABSTRACT

A system and method for creation and verification of utility bills with improved error detection is disclosed. Specifically, a user-configurable data structure is provided, which is sufficiently flexible to precisely simulate any utility tariff. The invention further relates to a computerized system and method for verifying utility bills utilizing a user-configurable data structure that simulates a utility tariff.

### CROSS REFERENCE TO RELATED APPLICATION

This application claims a domestic priority benefit to provisional application U.S. Ser. No. 61/172,401 filed Apr. 24, 2009, which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The processing and verification of utility bills is a necessary practice which is necessary for building owners and operators to minimize utility costs. The traditional approach is a costly and labour intensive practice typically employing full time staff to analyze each bill received. Ideally each component of the bill should be checked for accuracy. However, due to the variability in rate structures it is often difficult to perform this type of verification on a large scale. Instead it is common to use a more macroscopic analysis involving previous bills and historic trends. While this approach can be very effective it does suffer from a number of shortcomings. Firstly, it requires a trained eye to be able identify errors within data which can appear to be very random in nature. Secondly, only those errors which are large enough to be clearly observed amongst the natural variability are detected.

There is a need for a system which allows operators to perform “to the penny” verification of utility bills and thus improve error detection over traditional methods. In addition with the introduction of Time-of-Use rates in many jurisdictions, there is a need to be able to compare various time-of-use tariffs to determine the most cost effective option given utility use/demand profile. To meet these needs a system is required which allows the operator to define a utility tariff structure and easily perform bill validation analysis as well as tariff comparisons using data provided by a series of utility bills or a repository of interval meter readings.

### SUMMARY OF THE INVENTION

A first aspect of the present invention relates to a system and method for verification of utility bills with improved error detection. Specifically, a user-configurable data structure is provided, which is sufficiently flexible to precisely simulate any utility tariff.

Another aspect of the present invention relates to a computerized system and method for verifying utility bills utilizing a user-configurable data structure that simulates a utility tariff.

Still another aspect of the present invention relates to a run-time interpreter that parses and executes expressions stored in data fields. The interpreter uses code fields to perform any number interim calculations, and then evaluates them in sequence to generate all of the sub-calculations and totals that are found in utility bills. Prior to the present invention, all of the outputs were accomplished with standard database techniques, in which calculations are defined by a programmer or alternately in which a user selects among a list of hard-coded calculations. Advantageously, the present invention provides that the calculations are not hard-coded but are stored as expressions within operator-defined tariff components. This enables the operator to define the calculations him/herself without being bound to a set of pre-defined calculations.

Additionally, those operator-defined tariff components can reference external information sources, such as variable commodity price data feeds or items stored in other databases. The utility tariff engine can thus validate components of a bill where necessary inputs are not provided on the bill itself.

These and other aspects of the present invention will be discussed in greater detail hereinafter.

### BRIEF DESCRIPTION OF DRAWINGS

FIG. 1 is an exemplary graphical representation of the Utility Tariff Engine.

FIG. 2 is an exemplary graphical representation of example Tariff Components.

FIG. 3 is an exemplary graphical representation of the Tariff Solver.

FIG. 4 is an exemplary graphical representation of Tariff Component Expression evaluation.

FIG. 5 is an exemplary graphical representation of a user interface showing a sample time-of-use tariff.

FIG. 6 is an exemplary graphical representation of the procedure for utility bill validation.

FIG. 7 is an exemplary graphical representation of the procedure for utility bill generation.

### DETAILED DESCRIPTION

Various embodiments of the present invention will be described in detail with reference to the tables and figures, wherein like reference numerals represent like parts throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The program environment in which a present embodiment of the invention is executed illustratively incorporates a general-purpose computer or a special purpose device such as a hand-held computer. Details of such devices (e.g., processor, memory, data storage, display) may be omitted for the sake of clarity.

It is also understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

Accordingly, in one aspect, the present invention provides a computer implemented method for creating a utility bill from a dynamic tariff, said method comprising the steps of: inputting at least one tariff component into the dynamic tariff; identifying dependencies in each of the at least one tariff component; iterating through an evaluation process until each of the at least one tariff components are evaluated to solve the dynamic tariff; and creating a first utility bill from the solved dynamic tariff, wherein said dynamic tariff comprises at least one tariff component; wherein said at least one tariff component corresponds to at least one component of said first utility bill; and wherein said dynamic tariff corresponds to at least one utility tariff. The evaluation process may comprise determining an order to evaluate each of said at least one tariff component; and evaluating each of said at least one tariff component in the determined order. The method may further comprise the steps of: inputting data from a data source into the at least one tariff component; comparing said first utility bill to a second utility bill; and validating the second utility bill based on the comparison, wherein said data source is the second utility bill. The method may further comprise the steps of: inputting data from a data source into the at least one tariff component; and predicting a second utility bill based on the at least one utility tariff. The data source may be selected from the group consisting of estimated values, measured values from at least one utility meter, at least one historical utility bill, at least one historical interval meter reading, at least one historical non-interval meter reading, and a statistical baseline model. The method may further comprise the steps of: inputting data from a data source into the at least one tariff component; predicting a set of utility bills based on the at least one utility tariff; and predicting an annual utility budget based on the set of utility bills. The method may further comprise the steps of: inputting data from a data source into the at least one tariff component; predicting a first set of utility bills based on a first utility tariff; predicting a second set of utility bills based on a second utility tariff; predicting a first annual utility budget from the first set of utility bills; predicting a second annual utility budget from the second set of utility bills; comparing said first and second annual utility budgets; and selecting from the first and second utility tariff corresponding to a lowest utility budget selected from the group consisting of the first annual utility budget and the second annual utility budget. The tariff component may comprise meter data, or an expression. The expression may contain a reference to an internal system function or a reference to an external system function. The utility tariff may comprise a time-of-use tariff, or a market-based pricing tariff.

In another aspect, the present invention provides a computer system for recreating a utility tariff comprising: a processor; an input means; a display; a data source; a dynamic tariff comprising at least one tariff component; and at least one utility tariff, wherein said dynamic tariff corresponds to the least one utility tariff. The system may further comprise an order of dependencies identified in each of the at least one tariff component. The system may further comprise: data from said data source; a first utility bill created from solving the dynamic tariff; and a second utility bill, wherein the data from said data source is input into the at least one tariff component, wherein said data source is the second utility bill, and wherein the first utility bill is compared to the second utility bill to validate at least one component of the second utility bill. The system may further comprise: data from said data source; and a first utility bill, wherein the data from said data source is input into the at least one tariff component; and wherein the first utility bill is predicted from the at least one utility tariff. The data source may be selected from the group consisting of estimated values, measured values from at least one utility meter, at least one historical utility bill, at least one historical interval meter reading, at least one historical non-interval meter reading, and a statistical baseline model. The system may further comprise: data from said data source; a set of utility bills predicted from the at least one utility tariff; and an annual utility budget predicted from the set of utility bills, wherein the data from said data source is input into the at least one tariff component. The system may further comprise: data from said data source; a first utility tariff; a second utility tariff; a first set of utility bills predicted from the first utility tariff; a second set of utility bills predicted from the second utility tariff; a first annual utility budget predicted from the first set of utility bills; and a second annual utility budget predicted from the second set of utility bills, wherein the data from said data source is input into the at least one tariff component, and wherein a comparison of the first and second annual utility budgets allows a selection of a lowest utility budget from the group consisting of the first and second utility tariffs. The tariff component may comprise meter data, or at least one expression. The utility tariff may comprise a time-of-use tariff, or a market-based pricing tariff.

In yet another aspect, the present invention provides a computer implemented method for recreating at least one utility tariff, said method comprising the steps of: inputting at least one tariff component into a dynamic tariff; identifying dependencies in each of the at least one tariff component; determining an order to evaluate said at least one tariff component; evaluating said at least one tariff component in the determined order in an evaluation process; and iterating through an evaluation process until each of the at least one tariff components are evaluated to solve the dynamic tariff, wherein said dynamic tariff comprises at least one tariff component, and wherein said dynamic tariff corresponds to at least one utility tariff. The evaluation process may comprise: determining an order to evaluate each of said at least one tariff component; and evaluating each of said at least one tariff component in the determined order.

In another aspect, the present invention provides a computer readable memory having recorded thereon statements and instructions for execution by a computer to carry out the methods set out above.

### KEY DEFINITIONS

Tariff. A schedule of rates, fees or prices for any utility bill.

Dynamic Tariff. A representation, according to a preferred embodiment of the present invention, of a Tariff, which comprises at least one Tariff Component. The Dynamic Tariff is preferably represented in software in a computerized system, and is evaluated by the Utility Tariff Engine. There is no restriction on the number of Tariff Components, or the type of Tariff Component that may be represented within a Dynamic Tariff.

Tariff Component or Dynamic Tariff Component. A field that may represent at least one element found in a tariff, such as a unique identifier, a database expression, a mathematical function or calculation, a storage location, an assigned value, or a meter reading. The Tariff Component may also represent an element not found in the tariff itself and/or not provided on utility bills (e.g. a reference to an external piece of data).

Meter Component. A subset of Tariff Components that represent values measured by a utility meter, and optionally the type and nature of the measurement.

Non-Meter Component or User-Defined Component. A subset of Tariff Components that represent constant values, calculations, and/or data references and optionally the type and nature of the Tariff Component.

Tariff Component Expression. Any expression, mathematical, logical or otherwise, that is contained within a Tariff Component.

Utility Tariff Engine. A combination of novel software constructs that form a system with capabilities to represent and evaluative utility tariffs. In a preferred embodiment, the Utility Tariff Engine evaluates the Dynamic Tariff.

Tariff Solver. In a preferred embodiment, a run-time interpreter that parses and executes the expressions contained within the Tariff Components.

Time-of-Use (“TOU”) Tariff or interval tariff. Also known as Time of Day (TOD) or Seasonal Time of Day (SToD). A tariff that takes into account when a utility was consumed. It involves dividing the day, month and year into tariff slots and with higher rates at peak load periods and low tariff rates at off-peak load periods.

Market-Based Pricing. Commodity prices of electric power or other forms of energy determined in an open wholesale market system of supply and demand under which prices are set solely by agreement as to what buyers will pay and sellers will accept. Such prices could recover less or more than full costs, depending upon what the buyers and sellers see as their relevant opportunities and risks. For the consumer, trading activity in the wholesale market is reflected as continuously-changing commodity energy rates, typically adjusted hourly. A market-based pricing tariff is calculated, at least in part, on the wholesale market rate, meaning that commodity unit costs are not known in advance.

Meter Data Source or Meter Component Data. Refers to data that is measured, sampled, aggregated or otherwise indirectly or directly derived from the Meter. The data may also represent any measurable or sampled property of utility use/demand or meter operation.

Utility Bill Data Source. Refers to all data from a utility bill to be verified.

Interval Meter. Refers to an advanced utility meter that measures consumption or demand at a higher frequency than a conventional meter (typically at 5 minute, 15 minute, or 1 hour intervals); and optionally, but generally, communicates that information via some network back to the local utility for monitoring and billing purposes. This is contrasted against a traditional meter which is used to produce much less frequent readings, typically one per month.

Interval Readings. The higher frequency readings produced by an Interval Meter.

API or Application Programming Interface. An interface designed to enable interaction between software programs or systems.

The Dynamic Tariff

In the context of an electric utility or electricity retailer, a tariff is a published schedule of prices or terms of how electricity is sold. This would typically list the prices (or rates) for various services or components of the service such as: service charges, fees levied by the regulator, energy consumption (e.g. kWh) unit costs, time of day ranges for various unit cost levels, tiers defining volume-based discounts or increases and, peak demand (e.g. kW) charges. The tariff can also contain rules for usage and descriptions of the services provided. It is understood that reference to an electric utility is by way of example only, and that the present invention is operable for all utilities, such as natural gas, fuel oil, water, cable TV, telecommunications, transport of goods, etc.

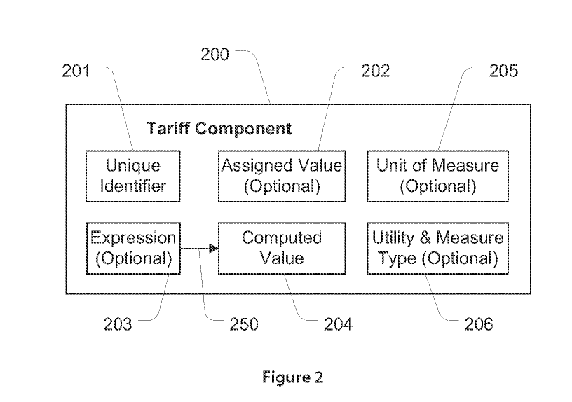

The Dynamic Tariff, as referred to in the context of the Utility Tariff Engine of the present invention, is an operator-defined collection of one or more Tariff Components, examples of which are represented graphically in FIG. 2.

All Tariff Components contain at least one of a number of common elements such as, for example, a unique identifier (e.g., a name), an optional expression which can be interpreted and evaluated, a storage location for the result obtained through evaluating the expression, an optional assigned value and an optional unit.

A special class of Tariff Components called Meter Components are those which represent values measured by the meter. Meter Components include additional properties that indicate the utility type and nature of the underlying measurement (e.g., consumption, demand, etc), and optionally measurement unit (e.g. kilowatt-hours, therms, cubic meters). The Dynamic Tariff comprises one or more Meter Components and, optionally, one or more Non-Meter Components. In its most basic form the Dynamic Tariff when representing a consumable utility will contain at least two components, a Meter Component representing Consumption and a Non-Meter Component representing a calculation to derive the final total. In defining Tariff Components the operator can recreate the logic of the rate tariff used by the utility provider or create a custom tariff of their own for the purpose of generating their own utility bills.

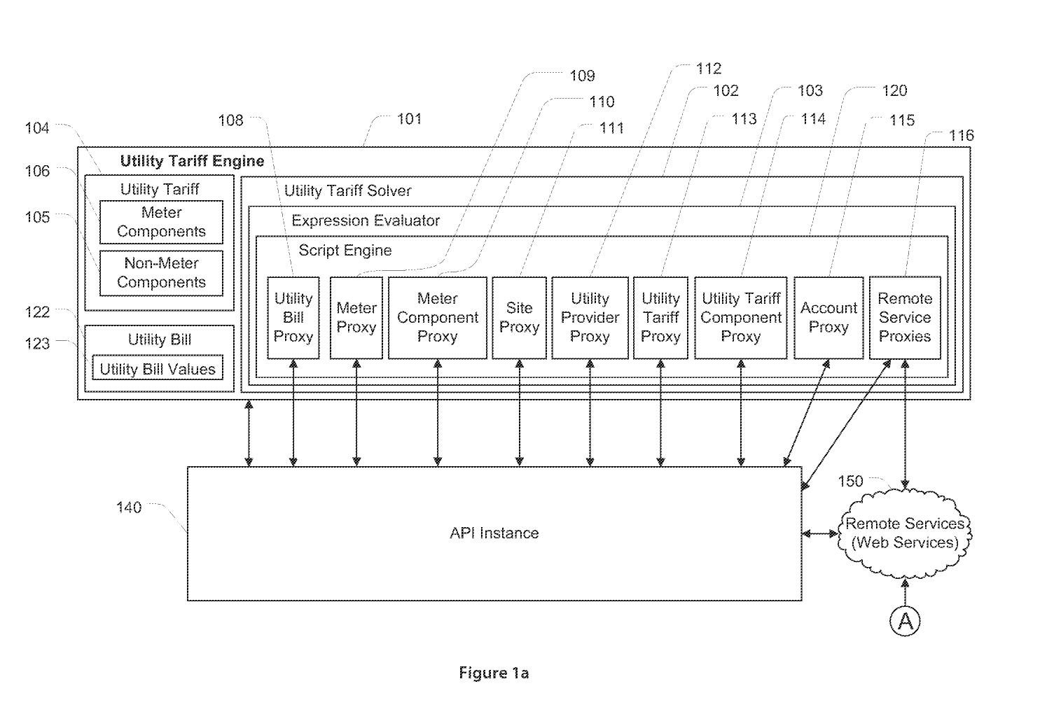

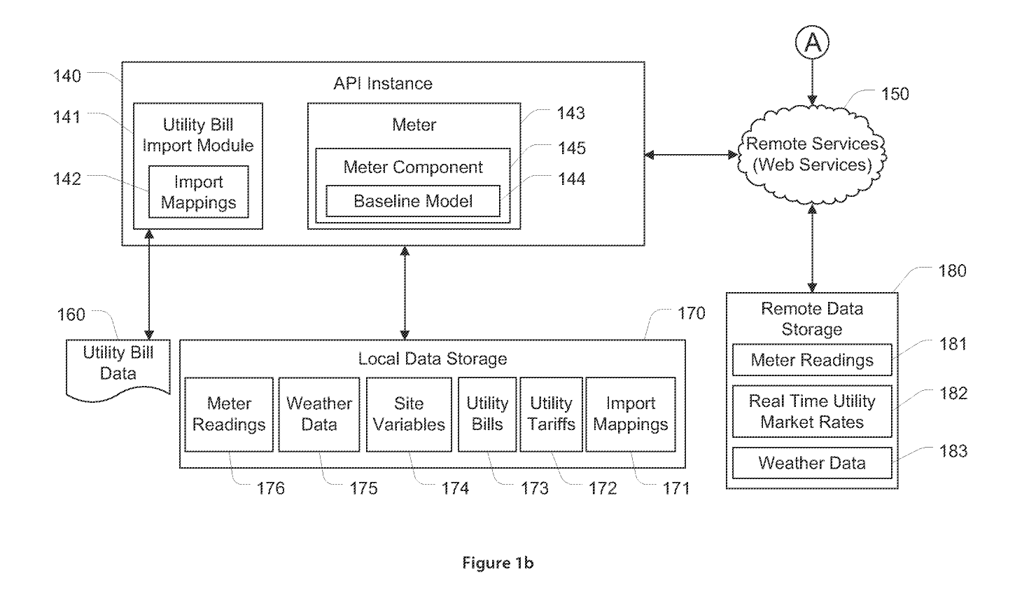

Referring to FIG. 2, in its most basic form, the Tariff Component 200 consists of a Unique Identifier 201, an optional Assigned Value 202, an optional Expression 203, a Computed Value 204, an optional Unit of Measure 205 and an optional Utility and Measurement Type 206. When a Utility and Measurement Type 206 has been specified the result is a special type of Tariff Component 200 called a Meter Component 106 (see FIG. 1). Meter Components represent those Tariff Components which represent metered values such as consumption of natural gas or peak demand or electricity. During the processing of the Utility Tariff, the result of evaluation of the Tariff Component Expression 203 is stored 250 as the Computed Value 204.

In a preferred embodiment, the operator defines one Tariff Component for each line item on a utility bill. The number of components defined by the operator depends on how much information the operator wishes to capture and the validation goals. However, to enable accurate bill validation, preferably all components which contribute to the final total are represented in the Dynamic Tariff.

For example, a simple Dynamic Tariff might include the Tariff Components shown in Table 1.

TABLE 1
An example of a simple Dynamic Tariff according to an aspect
of the present invention

| | Component | | |
|---|---|---|---|
| Name | Type | Expression | Unit |
| Consumption | Meter | | m³ |
| | Component | | |
| Marginal Rate | Non-Meter | 0.40 | |
| | Component | | |
| Sub Total | Non-Meter | [Consumption] * | $ |
| | Component | [Marginal Rate] | |
| Tax Rate | Non-Meter | 0.07 | |
| | Component | | |
| Final Total | Non-Meter | (1 + [Tax Rate]) * | $ |
| | Component | [Sub Total] | |

Advantageously, a user may define additional components beyond those necessary for computation. For example, components may be included to compute intermediate values for analysis purposes, or to use as a place holder for business- or accounting-related processes (e.g. an accounting department tracking number). Surprisingly, by not limiting the type of element represented by the Tariff Component, the Dynamic Tariff allows unforeseen benefits such as automated categorizing, analysis, optimization, etc. in other business processes beyond the utility bills themselves. One example of this would be a Tariff Component to identify the data source for the bill generated by the utility. Bills can be read visually by a person, read remotely via a data feed, read visually by the building owner, or simply estimated (i.e. not read at all). A similar bill is generated in all cases, and a “reading source” field could be used to deal with source data uncertainties when reporting conclusions.

Similarly, a Tariff Component could be used to indicate the means of data transfer to the database. Data transfer can be fully automated from the utility company's system or can have various levels of human involvement up to and included reading and transcribing data from low quality photocopy. In the case of manual entry, an experienced clerk will be much more reliable than a junior clerk. A “data transfer method” field that identified the data entry mechanism and the individual doing the entry would inform system users of the level of uncertainty at the data entry stage when interpreting outputs.

Inputs to the Utility Tariff Engine

FIG. 1 shows the Utility Tariff Engine 101 and the various data sources. The Meter Data Source provides data that is measured, sampled, aggregated or otherwise directly derived from the Meter. This data is also referred to as Meter Component Data and may represent any measurable or sampled property of utility use/demand or meter operation, including the relative and/or absolute time the measurement or sample was taken, the duration over which the measurement or sample was obtained, or the temporal relationship between measurements or samples, or other related temporal, scalar, or sequential characteristics. The Utility Bill Data Source provides all data from a utility bill to be verified. This includes but is not limited to the billing period, account number and/or other identifying properties, all measured values and units including consumption and demand, marginal rates, delivery charges, taxes, subtotal, and final total, in addition to historical bills. These data sources are accessible within the Utility Tariff Engine using the respective identifiers within the Tariff Component Expressions.

Referring to FIG. 1, the Utility Tariff Engine 101 enables the operator to process Utility Tariffs 104 and thus validate and/or generate utility bill(s) 107. The processing of the Utility Tariff 104 is performed by the Utility Tariff Solver 102 which contains an Expression Evaluator 103 capable of evaluating expressions contained within the Tariff Components 105, 106. These expressions may contain references to API 140 and Remote Service 150 functionality via Proxy objects 108-116 loaded into the Script Engine 120. API Proxy objects 108-115 leverage functionality inherent in the host software API 140 and access data 171-176 within the Local Data Storage 170 or from Remote Services 150 (i.e. Web Services). In addition, Remote Service Proxies 116 enable integration with other Remote Services 150 outside the scope of the host software and identified by the operator which conform to a predefined specification for exchanging structured information. The use of Remote Service Proxies allows for, but is not limited to, the integration Remote Data Storage 180 such as Meter Readings 181, Real Time Market Rates 182, and Weather Data 183.

Tariff Component Expressions

A Tariff Component may contain an expression which can be evaluated by the Utility Tariff Solver. These expressions can be simple static values, complex formulae incorporating mathematical statements or even references to other Tariff Components as can be seen in Table 1. In some situations even the types of expressions shown in Table 1 can be insufficient to fully and accurately describe the tariff. In a preferred embodiment, the present invention supports added functionality for querying one or more related objects or data sources (e.g. meter, baseline model, facility, commodity price feed, etc.) within the expressions.

An example where this is particularly useful is in the case of time-of-use tariffs. A time-of-use tariff is a special type of tariff which takes into account when the utility use occurs. These types of tariffs commonly segment the day into periods identified as ‘on’ or ‘off’ peak. Prior to the present invention, this diversity in tariff structures usually required some special processing within the software. Advantageously, since the Tariff Component Expressions may contain references to objects within the system, these complexities can be addressed within the Dynamic Tariff directly, resulting in a consistent approach to simulating tariffs regardless of their specific structure. Specifically, all types of tariffs, such as interval or non-interval, may be simulated using the same underlying constructs and processes, and hence the same Utility Tariff Engine. Previously, accounting for interval tariffs and non-interval tariffs would require two different systems (i.e., different engines).

In one aspect of the present invention, the functional differences between interval tariffs and non-interval tariffs can be handled within the Tariff Component Expressions. For example, when dealing with a Time-Of-Use Tariff, a Tariff Component Expression can query a utility meter for a consumption value within one or more on-peak period(s). For those tariffs incorporating continually-changing Market-Based Pricing, a Tariff Component Expression can query an external commodity price database or data feed. Thus all tariffs, regardless of type, can be simulated in a similar manner, while unique aspects can be addressed by the functionality provided within the Tariff Component Expressions.

The Tariff Solver

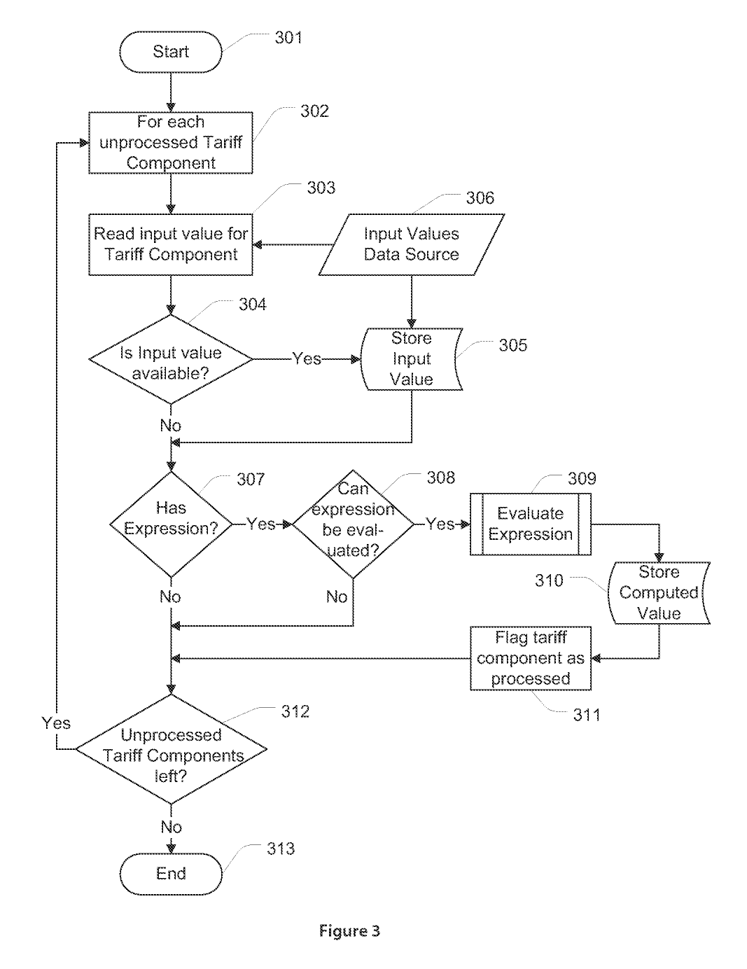

The preferred method employed by the Tariff Solver is represented graphically in FIG. 3. The role of the Tariff Solver is to solve the Tariff by evaluating each Tariff Component. The order in which Tariff Components are evaluated is determined by dependencies identified within the expression. More specifically, Tariff Components are solved as values for referenced items become available. In practice this is accomplished through an iterative approach wherein the solver attempts to evaluate each Tariff Component 106, 105, 200. The process begins at Step 301, where all Tariff Components are initially unprocessed. At the start of the iterative solving process (Step 302), for each unprocessed Tariff Component the solver attempts to read an Input Value from the Input Value Data Source and to store it in the Tariff Component (Steps 302 to 305) as the optional Assigned Value 202 (see FIG. 2). If the Tariff Component has an Expression 203, the solver determines if the Expression can be solved based on the state of the items referenced in the Expression (Steps 307, 308). If values for all dependents are available, the evaluation proceeds to Step 309, the result is stored as the Computed Value 204, and the Tariff Component is flagged as Processed (Step 311). If evaluation cannot proceed, the next Tariff Component is processed (Step 312). If, at the end of an iteration, the solver is unable to evaluate at least one Tariff Component, the solving process terminates (Steps 312, 313). This type of termination may be due to expression error, missing values or circular references. Circular references are permitted only where an input value has been assigned to the Tariff Component referenced in a circular manor prior to solving. References to dependents are replaced with each dependent's value prior to evaluation. When resolving references, the Utility Tariff Solver will use a Tariff Component's assigned value if it has been set, otherwise the computed value will be used.

Tariff Component Expression Evaluation

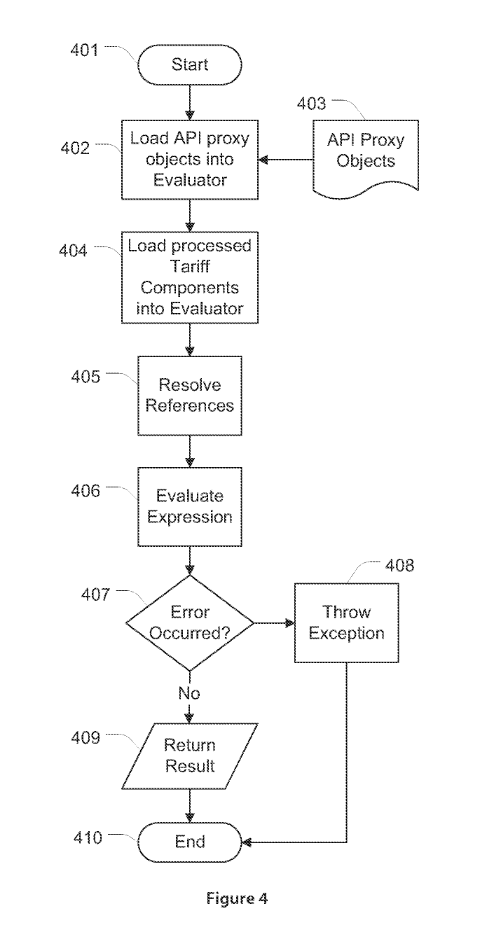

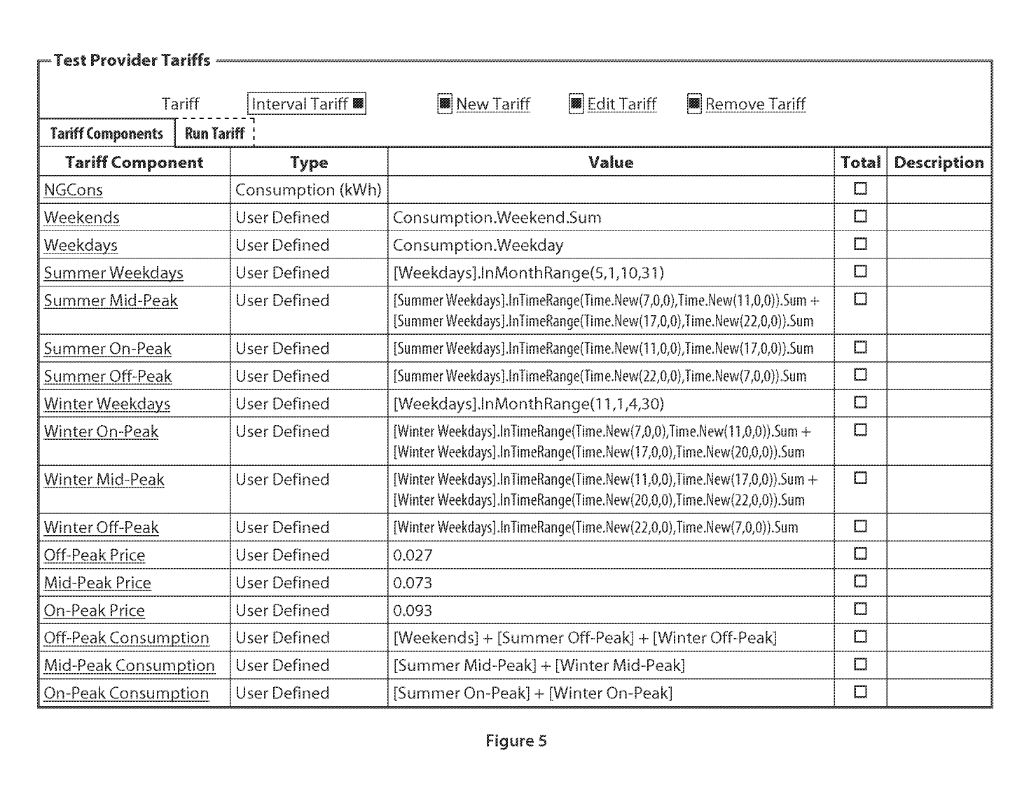

The preferred method to evaluate Tariff Component Expressions is represented graphically in FIG. 4. In a preferred embodiment, the expressions given to Tariff Components are evaluated using a scripting engine such as Microsoft VBScript, Python or any other dynamic language. The first step in this process is to load relevant API objects into the scripting engine (Steps 401 to 403). Each object is given a unique name so that reference to these objects may be resolved at evaluation time. In addition, processed Tariff Components are added to the scripting engine so that Tariff Component Expressions can reference other Tariff Components (Step 404). Prior to evaluating the Tariff Component Expressions, all references are resolved and converted from a ‘user friendly’syntax to a syntax more suitable for evaluation by the scripting engine (Step 405). For example the reference to the Tariff Component representing consumption might be written by the operator as ‘[Consumption]’. Once resolved, this reference would appear as an API call to obtain the referenced component, for example, Tariff.GetComponent(“Consumption”)'. Once all references have been resolved the expression is evaluated by the scripting engine (Step 406). If an error occurs (Step 407), an exception is thrown and is then processed by the Tariff Solver (Step 408). Otherwise, the result of the evaluation is returned to the Tariff Solver (Steps 409, 410).

### Example 1

### Solving a Simple Tariff

The simple Tariff shown in Table 2 illustrates the solving process. In this example, the Tariff Component identified by the name “Consumption” is given an expression which will query the underlying baseline model for a value.

TABLE 2
Solution to Simple Tariff (Iteration 0)

| | Component | | | Assigned | Calculated |
|---|---|---|---|---|---|
| Name | Type | Expression | Unit | Value | Value |
| Consumption | Meter | [Consumption].Model.Value | m³ | — | — |
| | Component | | | | |
| Marginal Rate | Non-Meter | 0.40 | $/m³ | — | — |
| | Component | | | | |
| Sub Total | Non-Meter | [Consumption] * [Marginal Rate] | $ | — | — |
| | Component | | | | |
| Tax Rate | Non-Meter | 0.07 | | — | — |
| | Component | | | | |
| Final Total | Non-Meter | (1+[Tax Rate]) * [Sub Total] | $ | — | — |
| | Component | | | | |

The solving process iterates through each component and if the expression does not contain any unresolved/unsolved references, it is evaluated. In the first iteration, the expressions for “Consumption”, “Marginal Rate”, and “Tax Rate” can be evaluated.

As previously described, the expression for “Consumption” queries the baseline model for a predicted value. This prediction will generally be a function of the variables affecting utility use, such as time, weather, and other operator-defined variables. If the baseline model predicts the consumption during the billing period to be 1,000, then the state of the Tariff after iteration 1 is shown in Table 3.

TABLE 3
Solution to Simple Tariff (Iteration 1)

| | Component | | | Assigned | Calculated |
|---|---|---|---|---|---|
| Name | Type | Expression | Unit | Value | Value |
| Consumption | Meter | [Consumption].Model.Value | m³ | — | 1000 |
| | Component | | | | |
| Marginal Rate | Non-Meter | 0.40 | $/m³ | — | 0.40 |
| | Component | | | | |
| Sub Total | Non-Meter | [Consumption] * [Marginal Rate] | $ | — | — |
| | Component | | | | |
| Tax Rate | Non-Meter | 0.07 | | — | 0.07 |
| | Component | | | | |
| Final Total | Non-Meter | (1+[Tax Rate]) * [Sub Total] | $ | — | — |
| | Component | | | | |

Table 3 shows two remaining components yet to be solved. The component “Sub Total” is the only one which does not contain unsolved references. Hence after iteration 2 “Sub Total” has been calculated as indicated in Table 4.

TABLE 4
Solution to Simple Tariff (Iteration 2)

| | Component | | | Assigned | Calculated |
|---|---|---|---|---|---|
| Name | Type | Expression | Unit | Value | Value |
| Consumption | Meter | [Consumption].Model.Value | m³ | — | 1000 |
| | Component | | | | |
| Marginal Rate | Non-Meter | 0.40 | $/m³ | — | 0.40 |
| | Component | | | | |
| Sub Total | Non-Meter | [Consumption] * [Marginal Rate] | $ | — | 400 |
| | Component | | | | |
| Tax Rate | Non-Meter | 0.07 | | — | 0.07 |
| | Component | | | | |
| Final Total | Non-Meter | (1+[Tax Rate]) * [Sub Total] | $ | — | — |
| | Component | | | | |

Only one component, the “Final Total” remains unsolved. All other tariff components have been evaluated and thus the expression for “Final Total” no longer contains unsolved references. After the third and final iteration the tariff has been completely solved as can be seen in Table 5.

TABLE 5
Solution to Simple Tariff (Iteration 3)

| | Component | | | Assigned | Calculated |
|---|---|---|---|---|---|
| Name | Type | Expression | Unit | Value | Value |
| Consumption | Meter | [Consumption].Model.Value | m³ | — | 1000 |
| | Component | | | | |
| Marginal Rate | Non-Meter | 0.40 | $/m³ | — | 0.40 |
| | Component | | | | |
| Sub Total | Non-Meter | [Consumption] * [Marginal Rate] | $ | — | 400 |
| | Component | | | | |
| Tax Rate | Non-Meter | 0.07 | | — | 0.07 |
| | Component | | | | |
| Final Total | Non-Meter | (1+[Tax Rate]) * [Sub Total] | $ | — | 428 |
| | Component | | | | |

Utility Bill Prediction

In Example 1, all tariff components were assigned an expression, which illustrates how the Utility Tariff Engine can also be used as a forecasting tool, allowing for the accurate prediction of each line item of a utility bill before it has been received. When the associated meter does not provide frequent interval readings, the underlying prediction is obtained through the use of a baseline model. The accuracy of this prediction is maximized by the use of an industry standard methodology (ASHRAE Guideline 14) in computing baseline models. If interval readings are available they are used to compute the predicted value.

Determining Annual Utility Budgets

The present invention also allows use of the Utility Tariff Engine to predict an annual utility budget under a specific utility tariff. Unlike utility bill prediction, which predicts the cost during a specific billing period, annual utility budget prediction determines anticipated cost over a typical year. Preferably, a baseline model may be used to provide predictions by way of Meter Component expressions, such as those shown in Example 1. However, when the focus is a typical or average year, the inputs to the model may represent conditions which would be expected in a typical year. In terms of weather, this means using composite data simulating the typical meteorological year for a range of weather stations, specifically the industry standard ASHRAE WYEC2 “Weather Year for Energy Calculations 2”, or the most current version of that data set. Similarly, any operator-defined variables (site-specific variables such as industrial output, meals served, beds occupied that influence energy use) will use values expected for the year being budgeted. Using the baseline models to generate predictions for the various Meter Components makes it possible to compute each line item on the utility bill for each month in the budget year.

Utility Tariff Comparison

Traditionally, utilities were monopolies within geographic areas and building owners have had no choice among utility providers or tariffs. This has changed in recent years, and continues to change as competition is introduced into utilities industries. One aspect of the present invention provides the user with a scientifically valid way to compare competing utility tariffs, to inform procurement decisions. When an annual budgeting process is applied to the same utility meter using more than one possible utility tariff, the budget outputs provide a means for the user to quickly compare expected annual costs for each tariff and thus select the most cost effective tariff option. The baseline model predictions are based on the user's best available predictions of future operating conditions, and incorporate industry standard “typical year” weather data, so the result is the most computationally reliable comparison possible. This is an improvement over previous methods which predicted costs based on previous years, or used simplified models which often reflect outcome bias of the party presenting the comparison.

Utility Bill Validation

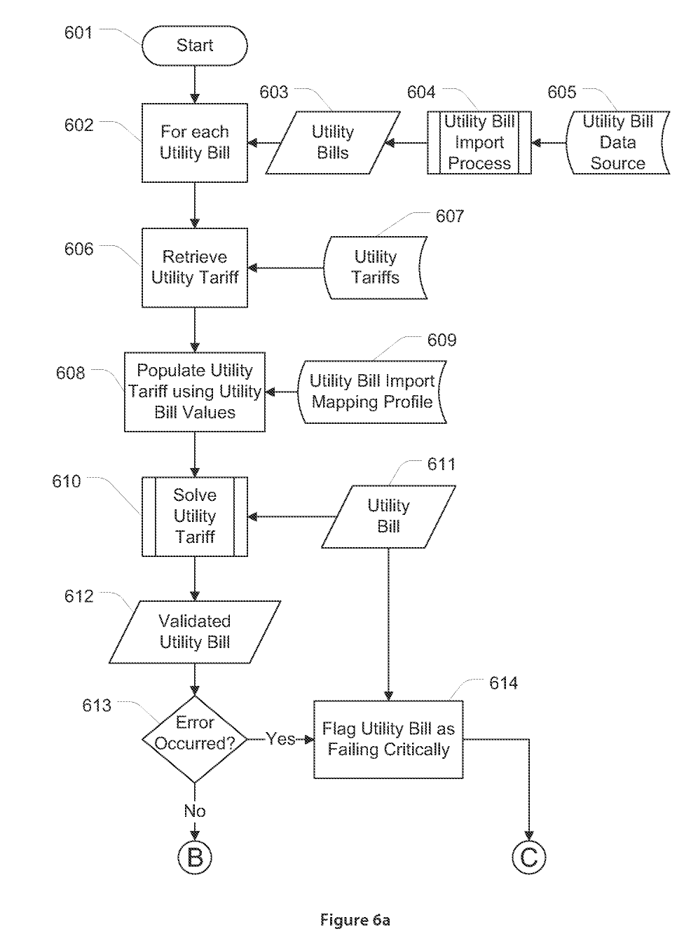

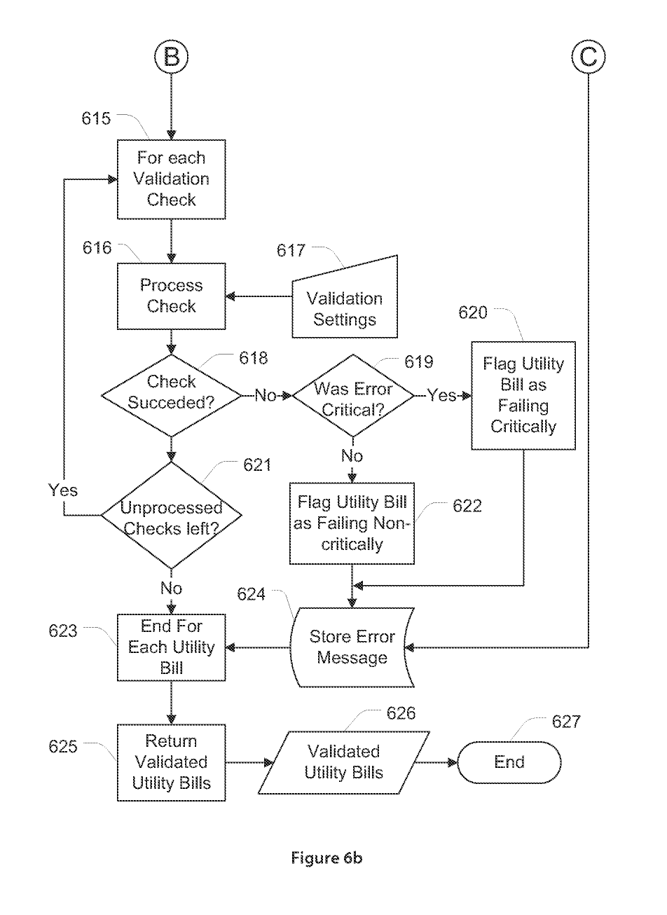

In another aspect of the present invention, the Utility Tariff Engine may be used to verify the accuracy of utility bills issued by utility providers, by duplicating the calculations published by the utility providers. This process is used to capture instances of incorrect billing, a situation that is surprisingly common, but which is usually missed without a rigorous validation process. Referring to FIG. 6, Utility Bills 603 within a Utility Bill Data Source 605 are imported into the system using a Utility Bill Import Process 604. The Utility Bill Data Source includes but is not limited to spreadsheets, flat files, local or remote data storage, and ERP systems. Each imported Utility Bill is then processed one at a time 602. Using the account information from the bill, the relevant Tariff is retrieved 606 from the collection of Utility Tariffs defined in the system 607. The values present on the bill are then used to populate 608 the Assigned Value 202 (see FIG. 2) on each relevant Tariff Component. This is accomplished using an operator-defined Utility Bill Import Mapping Profile 609 which establishes links between components in the incoming bill record and Tariff Components. Once the input values have been mapped, the Dynamic Tariff is solved 610 using the process illustrated in FIG. 3. If an error occurs 613 during the solving process, the error message is stored for review by the operator and the utility bill 611 is flagged 614 as failing critically. If the solving process was successful, a number of validation checks are performed 616 based on a series of validation settings 617 chosen by the operator. These checks may include, but are not limited to, overlapping billing dates, date gaps from previous bill, variance checks between input and calculated values, previous bill variance, and previous year variance. If a check fails, an error message is stored and it is then determined if the failure was critical 618, 619. If so, the bill is flagged as failing critically 620 and no further checks are performed. Otherwise the bill is flagged as failing non-critically 622 and any remaining checks are executed 621.

### Example 2

### Utility Bill Validation

In Example 1, none of the Tariff Components was assigned a value, however, it is possible to do so, which allows for the validation of received utility bills. Validation of utility bill values is performed through a comparison between the assigned and calculated values. For Meter Components, this results in a direct comparison between either the baseline model prediction or interval readings for traditional meters and interval meters, respectively, and that which is indicated on the bill.

This can be demonstrated by expanding on Example 1. Assume that the utility bill contains the information shown in Table 6.

TABLE 6
Utility Bill Components for Example 2

| Bill Component | Value |
|---|---|
| Consumption | 1000 m³ |
| Marginal Rate | $0.45/m³ |
| Sub Total | $400 |
| Tax Rate | 7% |
| Final Total | $481.50 |

A comparison of the assigned values to their respective, previously calculated Tariff Component values is set out in Table 7.

TABLE 7
Comparison of Assigned and Previously Calculated Tariff Components

| | Component | | | Assigned | Calculated |
|---|---|---|---|---|---|
| Name | Type | Expression | Unit | Value | Value |
| Consumption | Meter | [Consumption].Model.Value | m³ | 1000 | 1000 |
| | Component | | | | |
| Marginal Rate | Non-Meter | 0.40 | $/m³ | 0.45 | 0.40 |
| | Component | | | | |
| Sub Total | Non-Meter | [Consumption] * [Marginal Rate] | $ | 450 | 400 |
| | Component | | | | |
| Tax Rate | Non-Meter | 0.07 | | 0.07 | 0.07 |
| | Component | | | | |
| Final Total | Non-Meter | (1+[Tax Rate]) * [Sub Total] | $ | 481.50 | 428 |
| | Component | | | | |

In comparing the assigned and calculated values it is easy for the operator to identify any source of divergence. In this Example 2, the variance in the Final Total can be traced back to the marginal rate, and it would appear that the utility provider has adjusted this value since the time when the Tariff was created. While this is a simple example the procedure outlined can be applied to validate very complicated tariff structures.

Support for Interval Meters

In a preferred embodiment, the Tariff Engine supports Interval Readings and tariffs based on Interval Readings. The system stores the Interval Readings as they are received and performs automatic rollups at varying intervals (day, week, month, etc). Tariffs defined for interval meters may contain expressions which when evaluated by the Tariff Solver query this data through a number of exposed API objects/functions to accurately resolve the Tariff Component values. Thus the expressions can reference objects which manage the collection of interval data. A list of expressions which operate on interval data are shown in Table 8. In these examples the Meter Component identified by the name “Consumption” represents the consumption component of an interval meter.

TABLE 8
Interval Meter Tariff Expression Examples

| Expression | Description |
|---|---|
| [Consumption].Sum | Obtains the sum of all interval consumption readings |
| [Consumption].Max | Obtains the max interval consumption reading |
| [Consumption].Min | Obtains the min interval consumption reading |
| [Consumption].Avg | Obtains the average interval consumption reading |
| [Consumption].InRange(Date.New(“1/1/2009”),Date.New(“2/1/2009”)) | Obtains the collection of interval consumption readings |
| | between Jan. 1, 2009 and Feb. 1, 2009 |
| [Consumption].InRange(Date.New(“1/1/2009”),Date.New(“2/1/2009”)).Sum | Obtains the sum of all interval consumption readings |
| | between Jan. 1, 2009 and Feb. 1, 2009 |
| [Consumption].Weekday | Obtains the collection of interval consumption readings |
| | occurring on weekdays |
| [Consumption].Weekday.Sum | Obtains the sum of interval consumption readings |
| | occurring on weekdays |
| [Consumption].Weekday.InTimeRange(Time.New(12,0,0),Time.New(17,0,0)) | Obtains the collection of interval consumption readings |
| | occurring on weekdays between 12:00pm and 5:00pm |
| [Consumption].Weekday.InTimeRange(Time.New(12,0,0),Time.New(17,0,0)).Sum | Obtains the sum of interval consumption readings |
| | occurring on weekdays between 12:00pm and 5:00pm |

By leveraging the functionality provided by these expressions it is possible to define Dynamic Tariffs that use the interval meter readings as the source for the computed values as illustrated in Table 9.

TABLE 9
Sample Interval Meter Tariff

| | Component | | |
|---|---|---|---|
| Name | Type | Expression | Unit |
| Consumption | Meter | | kWh |
| | Component | | |
| On-Peak | Meter | [Consumption]. | kWh |
| Consumption | Component | InTimeRange(Time.New(11,0,0),Time.New(17,0,0)).Sum | |
| Off-Peak | Meter | [Consumption]. | kWh |
| Consumption | Component | InTimeRange(Time.New(17,0,0),Time.New(11,0,0)).Sum | |
| On-Peak Rate | Non-Meter | 0.093 | $/kWh |
| | Component | | |
| Off-Peak Rate | Non-Meter | 0.027 | $/kWh |
| | Component | | |
| On-Peak Charge | Non-Meter | [On-Peak Consumption] * [On-Peak Rate] | $ |
| | Component | | |
| Off-Peak Charge | Non-Meter | [Off-Peak Consumption] * [Off-Peak Price] | $ |
| | Component | | |
| Sub Total | Non-Meter | [On-Peak Charge] + [Off-Peak Charge] | $ |
| | Component | | |
| Tax Rate | Non-Meter | 0.07 | |
| | Component | | |
| Final Total | Non-Meter | (1 + [Tax Rate]) * [Sub Total] | $ |
| | Component | | |

Support for Time-of-Use (“TOU”) Tariffs

In another preferred embodiment, the Tariff Engine supports tariffs based on TOU rates. In the context of the Tariff Engine, the Meter Components in a TOU Tariff have the capability to represents collections of meter readings occurring within defined time and/or date ranges, as opposed to single reading values. This capability can make use of Interval Readings if they are required for calculation by the particular TOU tariff and supported by an Interval Meter installation. The Tariff Solver evaluates TOU Tariffs using the same procedure as non-TOU Tariffs. The only difference between the TOU Tariff and the non-TOU tariff is the use of dynamic references within the TOU Tariff Component Expressions. Specifically, the TOU expressions can reference objects which manage the collection of TOU data. Examples of such expressions are shown in Table 10.

### Example 3

### Time-of-Use (TOU) Tariff

A sample TOU Tariff which exhibits two rates, one for on-peak and another for off-peak, is shown in Table 10.

TABLE 10
Example Time-of-Use (TOU) Tariff

| | Component | | |
|---|---|---|---|
| Name | Type | Expression | Unit |
| Consumption | Meter | [On-Peak Consumption] + [Off-Peak | kWh |
| | Component | Consumption] | |
| On-Peak | Meter | [On-Peak Consumption].Value | kWh |
| Consumption | Component | | |
| Off-Peak | Meter | [Off-Peak Consumption].Value | kWh |
| Consumption | Component | | |
| On-Peak Rate | Non-Meter | 0.093 | $/kWh |
| | Component | | |
| Off-Peak Rate | Non-Meter | 0.027 | $/kWh |
| | Component | | |
| On-Peak Charge | Non-Meter | [On-Peak Consumption] * [On-Peak Rate] | $ |
| | Component | | |
| Off-Peak Charge | Non-Meter | [Off-Peak Consumption] * [Off-Peak Price] | $ |
| | Component | | |
| Sub Total | Non-Meter | [On-Peak Charge] + [Off-Peak Charge] | $ |
| | Component | | |
| Tax Rate | Non-Meter | 0.07 | |
| | Component | | |
| Final Total | Non-Meter | (1 + [Tax Rate]) * [Sub Total] | $ |
| | Component | | |

Validation of utility bills based on TOU Tariffs is performed using the same procedure as non-TOU Tariffs. In this case the on and off peak consumption values read from the utility bill will be compared to the values predicted by the respective baseline models.

Support for Market-Based Pricing

In yet another preferred embodiment of the present invention, the Utility Tariff Engine can be used to accept continually-changing Market-Based Pricing data provided by the electrical system operator, combine it with Interval Readings, and accurately reproduce the retail charges for a billing period. This is accomplished by exposing a data feed of current and historic rates through an API object accessible via the tariff component expression. In the example shown in Table 11, the expression defined for the Tariff Component “Consumption Marginal Rate” retrieves the per unit charge for consumption for the period of interest by querying the utility provider object.

TABLE 11
Sample Market-Based Pricing Tariff

| | Component | | |
|---|---|---|---|
| Name | Type | Expression | Unit |
| Consumption | Meter | | kWh |
| | Component | | |
| Consumption | Non-Meter | [Provider].GetRate(“Consumption”,[StartDate],[EndDate]) | $ |
| Marginal Rate | Component | | |
| Consumption | Non-Meter | [Consumption] * [Consumption Marginal Rate] | $ |
| Charge | Component | | |
| Sub Total | Non-Meter | [Consumption Charge] | $ |
| | Component | | |
| Tax Rate | Non-Meter | 0.07 | |
| | Component | | |
| Final Total | Non-Meter | (1 + [Tax Rate]) * [Sub Total] | $ |
| | Component | | |

Utility Bill Generation

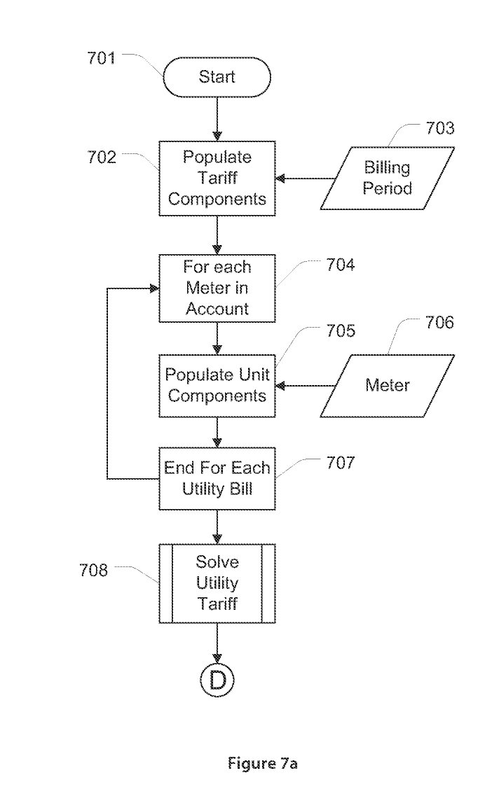

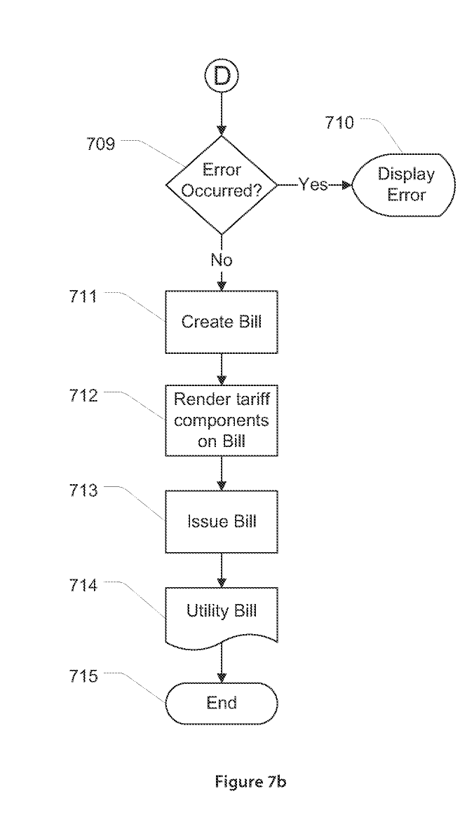

In yet another aspect of the present invention, the Utility Tariff Engine can be used not only to perform bill validation but also to perform bill generation as illustrated in FIG. 7. In this application, the process starts 701 with the operator defining the Billing Period (start and end date) 703 which is then used to populate the relevant Tariff Components 702. Each Utility Meter associated with the Account is retrieved and used to populate the relevant Meter Components (704 to 707) with consideration of the operator-supplied billing period 703. This can either be actual meter readings (values) or proxy objects which enable querying of the meter for specific information via the Tariff Component Expression 203 (see FIG. 2). This includes but is not limited to consumption, min/max demand, real demand, apparent demand, power factor, etc. The Dynamic Tariff is then solved using the process illustrated in FIG. 3. If an error occurs 709 during the solving process it is displayed for operator review 710. Otherwise the bill is created 711 and the computed value for each tariff component is rendered on the bill as line items 712. The utility bill is then issued 713 using any chosen medium (e.g., email, fax, print, etc.) before processing the next account. Advantageously, this embodiment of the invention can be used in a landlord/tenant situation, in which the landlord bills the tenant for actual utility use. It can also be used by facility owners to allocate utility costs among profit or cost centres.

1. A method for creating a utility bill from a dynamic tariff, said method comprising the steps of:
inputting at least one tariff component into the dynamic tariff;
identifying dependencies in each of the at least one tariff component;
iterating through an evaluation process until each of the at least one tariff components are evaluated to solve the dynamic tariff; and
creating a first utility bill from the solved dynamic tariff,
wherein said dynamic tariff comprises at least one tariff component; wherein said at least one tariff component corresponds to at least one component of said first utility bill; and wherein said dynamic tariff corresponds to at least one utility tariff.

2. The method of claim 1, wherein said evaluation process comprises:
determining an order to evaluate each of said at least one tariff component; and evaluating each of said at least one tariff component in the determined order.

3. The method of claim 1, wherein said method comprises the steps of:
inputting data from a data source into the at least one tariff component;
comparing said first utility bill to a second utility bill; and
validating the second utility bill based on the comparison,
wherein said data source is the second utility bill.

4. The method of claim 1, wherein said method comprises the steps of:
inputting data from a data source into the at least one tariff component; and
predicting a second utility bill based on the at least one utility tariff,
wherein said data source is selected from the group consisting of estimated values, measured values from at least one utility meter, at least one historical utility bill, at least one historical interval meter reading, at least one historical non-interval meter reading, and a statistical baseline model.

5. The method of claim 1, wherein said method comprises the steps of:
inputting data from a data source into the at least one tariff component;
predicting a set of utility bills based on the at least one utility tariff; and
predicting an annual utility budget based on the set of utility bills,
wherein said data source is selected from the group consisting of estimated values, measured values from at least one utility meter, at least one historical utility bill, at least one historical interval meter reading, at least one historical non-interval meter reading, and a statistical baseline model.

6. The method of claim 1, wherein said method comprises the steps of:
inputting data from a data source into the at least one tariff component;
predicting a first set of utility bills based on a first utility tariff;
predicting a second set of utility bills based on a second utility tariff;
predicting a first annual utility budget from the first set of utility bills;
predicting a second annual utility budget from the second set of utility bills;
comparing said first and second annual utility budgets; and
selecting from the first and second utility tariff corresponding to a lowest utility budget selected from the group consisting of the first annual utility budget and the second annual utility budget.

7. The method of claim 1, wherein the at least one tariff component comprises meter data.

8. The method of claim 1, wherein the at least one tariff component comprises an expression.

9. The method of claim 1, wherein the at least one tariff component comprises an expression, and wherein said expression contains a reference selected from the group consisting of a reference to an internal system function and a reference to an external system function.

10. The method of claim 1, wherein the at least one utility tariff comprises a time-of-use tariff.

11. The method of claim 1, wherein the at least one utility tariff comprises a market-based pricing tariff.

12. A system for recreating a utility tariff comprising:
a data source; a dynamic tariff comprising at least one tariff component; and at least one utility tariff,
wherein said dynamic tariff corresponds to the least one utility tariff.

13. The system of claim 12, wherein the system further comprises an order of dependencies identified in each of the at least one tariff component.

14. The system of claim 12, wherein the system further comprises:
data from said data source; a first utility bill created from solving the dynamic tariff; and a second utility bill,
wherein the data from said data source is input into the at least one tariff component, wherein said data source is the second utility bill, and wherein the first utility bill is compared to the second utility bill to validate at least one component of the second utility bill.

15. The system of claim 12, wherein the system further comprises:
data from said data source; and a first utility bill,
wherein the data from said data source is input into the at least one tariff component; wherein said data source is selected from the group consisting of estimated values, measured values from at least one utility meter, at least one historical utility bill, at least one historical interval meter reading, at least one historical non-interval meter reading, and a statistical baseline model; and wherein the first utility bill is predicted from the at least one utility tariff.

16. The system of claim 12, wherein the system further comprises:
data from said data source; a set of utility bills predicted from the at least one utility tariff; and an annual utility budget predicted from the set of utility bills,
wherein the data from said data source is input into the at least one tariff component, and wherein said data source is selected from the group consisting of estimated values, measured values from at least one utility meter, at least one historical utility bill, at least one historical interval meter reading, at least one historical non-interval meter reading, and a statistical baseline model.

17. The system of claim 12, wherein the system further comprises:
data from said data source; a first utility tariff; a second utility tariff; a first set of utility bills predicted from the first utility tariff; a second set of utility bills predicted from the second utility tariff; a first annual utility budget predicted from the first set of utility bills; and a second annual utility budget predicted from the second set of utility bills,
wherein the data from said data source is input into the at least one tariff component, and wherein a comparison of the first and second annual utility budgets allows a selection of a lowest utility budget from the group consisting of the first and second utility tariffs.

18. The system of claim 12, wherein the at least one tariff component comprises meter data.

19. The system of claim 12, wherein the at least one tariff component comprises at least one expression.

20. The system of claim 12, wherein the at least one utility tariff comprises a time-of-use tariff.

21. The system of claim 12, wherein the at least one utility tariff comprises a market-based pricing tariff.

22. A method for recreating at least one utility tariff, said method comprising the steps of:
inputting at least one tariff component into a dynamic tariff;
identifying dependencies in each of the at least one tariff component;
determining an order to evaluate said at least one tariff component;
evaluating said at least one tariff component in the determined order in an evaluation process; and
iterating through an evaluation process until each of the at least one tariff components are evaluated to solve the dynamic tariff,
wherein said dynamic tariff comprises at least one tariff component, and wherein said dynamic tariff corresponds to at least one utility tariff.

23. The method of claim 22, wherein said evaluation process comprises:
determining an order to evaluate each of said at least one tariff component;
and evaluating each of said at least one tariff component in the determined order.
